(19) United States
(12) Patent Application Publication
(10) Pub. No.: US 2017/0269677 A1
(43) Pub. Date: Sep. 21, 2017

(54) Method and Device for the Administration of the Energy Consumption of a Portable Electronic Device Activated by Gestures or Movements

(71) Applicant: Digital Experiences S.A.P.I. de C.V., Col. Condesa Distrito Federal (MX)

(72) Inventor: Jesus Ricardo Arriaga Fuentes, Col. Escandon Distrito Federal (MX)

(73) Assignee: Digital Experiences S.A.P.I. DE C.V., Col. Condesa Distrito Federal (MX)

(21) Appl. No.: 15/324,684

(22) PCT Filed: Jul. 8, 2015
(86) PCT No.: PCT/MX2015/000099

§ 371 Date: Jun. 6, 2017

(30) Foreign Application Priority Data
Jul. 8, 2014 (MX) 2014008351

(51) Int. Cl. G06F 1/32

(52) U.S. Cl. CPC G06F 1/3287; G06F 1/3296; G06F 1/3212

(57) ABSTRACT

A portable electronic device and method that functions as a user interface to notify and monitor, in particular, and to interact, in general, with the user with regard to events generated depending on an application that may or may not use different external services coming from the application and/or the host system and the coupling and decoupling method of the electronic device of the invention allowing its use in multiple situations. The electronic device may consist of a cover containing one or more data microprocessors, one or more wireless communication modules, one or more color displays, one or more general-purpose sensing components, one or more voltage regulators, one or more voltage boosters, one or more electric batteries, one or more battery charge management circuits, one or more battery sensors, one or more amplifier circuits for one or more actuators, one or more oscillators and connection circuitry.

### TECHNICAL FIELD OF THE INVENTION

This invention concerns a portable electronic device that manage its own power from touch or motion inputs allowing the execution of user applications.

The purpose of this invention is to provide a portable electronic device that works as a user interface by notifying and monitoring, in particular, and by interacting, in general, with the user regarding events generated depending on an application that may use different external services and the coupling or de-coupling method from the electronic device of the invention which allows its use in multiple circumstances.

The electronic device consists of a casing that may contain one, several or all of the following items (without limitation): one (or more) data processing circuit(s), one (or more) wireless communication module(s), one (or more) color electronic display(s), one (or more) general-purpose sensors; one (or more) voltage regulator(s), one (or more) voltage booster(s), one (or more) electric batteries; one (or more) amplifier circuits for the actuators, one (or more) motor(s), one (or more) speaker(s), one (or more) oscillator(s) or connection circuits for a portable and autonomous operation. The method comprises a coupling and de-coupling mechanism of the cover with or without power terminals in order to be mounted and dismounted from an autonomous clamp system through which electric supply or data exchanging may be performed.

### BACKGROUND OF THE INVENTION

There are some portable devices offering advanced autonomous functions in a wide extent of its operations thanks to the use of smart low-consumption batteries or components. Such devices manage battery power, control sensors and actuators, process data and present it to the user, and transmit from and to a host device (for example, but not limited to, a smart phone) without user intervention. An example application, without limitation, is the “incoming call” notification or messages received by the smart phone from different devices. Other applications use sensors that may be installed within this device in order to calculate, predict or recommend useful information to the user.

Regardless of the different options and features included in these kind of devices, there are several disadvantages depending on the system, which encompass: charging, battery consumption and shelf-life, mechanical user interface (for example, but not limited to, buttons), functional autonomy with only one kind of host or specific platform, monochromatic electronic display or the lack of display, the use of a fixed mechanical connector, among others. Such features reduce the user's operating possibilities.

The terms used herein are defined below. A device is understood to be a mechanism developed to produce an intended action. An electronic device is a mechanism controlling electrons' behavior in a circuit to produce an intended action. A portable electronic device is the mechanism controlling electrons' behavior in a circuit to produce an intended action and whose power supply is integrated within the circuit.

A data processing circuit is an electronic device that may contain different components to perform data processing or operations according to a series of instructions previously defined. The components that such a device may contain include, but are not limited to, the following: a microprocessor, a microcontroller, random access memory (RAM), non-volatile memory (e.g., FLASH), a data bus and/or supply voltage, arithmetic logic units and/or clocks, among others.

A wireless communication module is an electronic device that may contain different components in order to transmit and/or receive electromagnetic signals with a certain modulation technique and/or communication protocol for data exchange with another autonomous device with the same required components to transmit or receive electromagnetic signals using the same modulation technique and/or communication protocol.

A color electronic display is an electronic device organized in a matrix with electroluminescent components at the red, green and blue wavelengths, as well as in necessary control components for image displaying.

A sensor is known to be a transducer device which turns the power from any particular phenomenon into electric signals. A general-purpose sensor is any kind of sensor that measures physical variables from the environment in which they are found, such as, but not limited to, temperature, acceleration, shifts, luminous intensity, pressure or humidity.

A voltage regulator is an electronic device which maintains an output voltage at a predetermined level, with certain accuracy and stability, under the influence of a fixed or variable charge requiring a fixed or variable current from the voltage regulator of an input voltage higher and/or more variable than the output voltage.

A voltage booster is an electronic device which maintains an output voltage in a default level, with certain accuracy and stability, under the influence of a fixed or variable charge requiring a fixed or variable current from the voltage booster of an input voltage lower and/or more variable than the output voltage.

The electric rechargeable battery is a storage cell with the property of supporting a certain number of recharge cycles.

A charge management circuit is an electronic device which provides means and methods for optimal use of rechargeable batteries.

An amplifier circuit for actuator(s) is an electronic device which supplies the means and methods necessary to maintain a current and/or torque voltage in a determined actuator through the necessary means and methods.

A motor is an electromagnetic mechanism that generates circle movements in a mass. A speaker is an electroacoustic device that turns electric signals into sounds. Generally, both the motor and the speaker are part of actuators, which are mechanisms that turn electric power into any other type of power; for example, but not limited to, mechanical, acoustic, hydraulic or thermic power.

An oscillator is an electronic circuit consisting of components that generate an oscillation at a determined frequency with certain stability and accuracy.

In addition, the “user-application interface” is referred to in order to name the electronic device which allows the user to enter information into an application executed in a host system or to obtain perceptible results of said application.

User is the individual operating the interface. To notify refers to informing the user about events that are taking place, have taken place or will take place. A notification is a notice of any particular event. Furthermore, the notice may refer to a visual, acoustic or mechanical action oriented to the user. Monitoring means that data and sensors may or may not be intentionally processed, both internally and externally, by an application that may be executed in an internal or external host system. Interaction refers to the action mutually performed between the user and the application through notifications and/or monitoring.

External services are those programs executed on computers and/or on private or public computer networks providing information services and to which access is allowed by a communication interface of the host; some examples of external services are file storage, instant messaging, social network and/or e-mail transmission. Events are detectable-recurrent phenomena whose nature depends on the service from which they originate; for instance, but not limited to, an event is when an email or message arrives in the user's inbox.

The application in this context is a software that may or not use external services, the host resources where it is executed and/or all available resources to process data from any matter and to present specific information to the user.

The host is a computer system where the application is executed, which may be the same electronic device of the invention and/or an external and autonomous computer system.

Invention Description

### BRIEF DESCRIPTION OF THE DRAWINGS

FIG. 1 presents a chart showing invention components.

FIGS. 2 and 3 present the methodology to control the power supply during operation of the portable electronic device using touch or motion inputs to execute user applications.

FIGS. 4, 5 and 6 present the user's movements which result in the device having specific positions.

FIG. 7 presents a watch disassembly in which the invention method is used.

### DETAILED DESCRIPTION OF THE INVENTION

The invention is a portable electronic device inside a case that may incorporate, but is not limited to, one (or more) rechargeable battery or batteries; one (or more) battery charge management circuit(s); voltage regulator(s), data processing circuit(s), wireless communication module(s), sensor(s), actuator(s), color electronic display(s) and/or circuitry related to monitoring, transmission, processing, visualization, and/or notification of information regarding the user's programmable events through an application executed within an internal or external host system.

This invention has the necessary subsystems to manage battery charge and consumption, user gesture recognition, shared operation or execution with external host devices by wireless communication and color image display on a screen. The case contains all necessary components to operate independently, for instance, but not limited to, waiting for the occurrence of predetermined events. The invention device may be used independently of an external host as well as a mechanical fixing support regardless of its own structure and may or may not interact with other systems both mechanically and electrically in order to extend the device features of the invention through the coupling and de-coupling method.

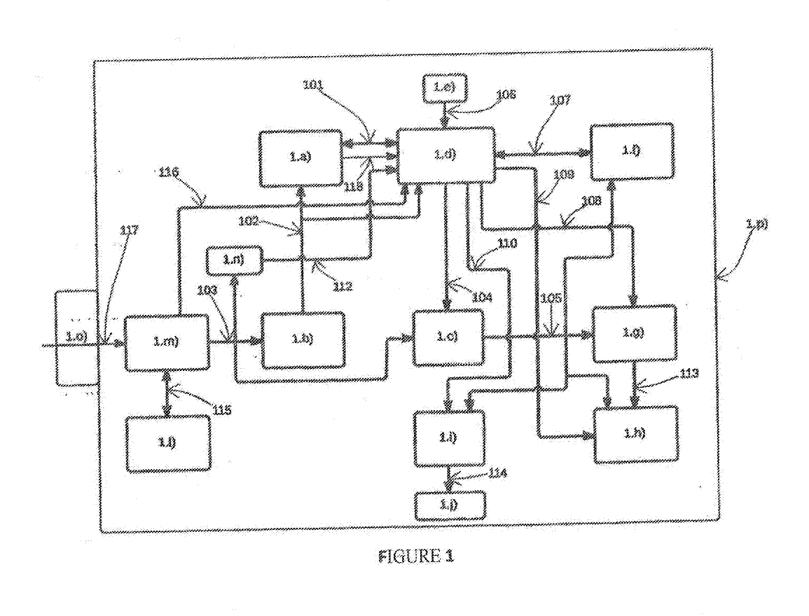

The electronic device of the invention comprises, but is not limited to, the following components (shown in FIG. 1):

1.a) One or more general-purpose sensing component(s) (sensors) with associated circuitry.

1.b) One or more always-active low-power voltage regulator(s)

1.c) One or more controllable voltage regulator(s)

1.d) One or more data processing circuit(s) with one or more operation modes in low-power consumption, serial connectivity with ports 12C, SPI and UART, general-purpose inputs and outputs, counters and analog to digital converter.

1.e) One or more oscillator(s), for example, but not limited to, piezoelectric and/or ceramic oscillators.

1.f) One or more wireless communication module(s) with serial interface and operation modes in low-power consumption.

1.g) One or more controllable voltage booster circuit(s).

1.h) One or more controllable RGB electronic display(s) with serial interfaces.

1.i) One or more amplifier circuit(s) for the actuator(s)

1.j) One or more actuator(s)

1.l) One or more batteries

1.m) One or more battery charge management circuit(s) and

1.n) One or more battery charge sensor(s)

1.o) One or more coupling and de-coupling mechanisms and mechanical or electrical de-coupling

1.p) A case made from one or more materials, variable dimensions, consisting of one or more fixed or mobile parts which provide mechanical structure and support to the electric device of the invention. It may or may not contain a coupling or de-coupling mechanism, either internally or externally, with or without electrical terminals to enable communication or transmission of power with an external and autonomous system.

The device is interconnected through the signals shown in FIG. 1 detailed below:

101.—the serial data bus between general-purpose sensing component(s) (1.a) and data microprocessor(s) (1.d)

102.—The power bus from always-active voltage regulators (1.b) which supply power to general-purpose sensing elements (1.a) and to data processor(s) (1.d)

103.—Variable power bus from charge management circuit(s) (1.m) that supplies always-active voltage regulators (1.b) and controllable voltage regulator(s) (1.c). Furthermore, it works as a monitoring signal for battery charge sensor(s) (1.n).

104.—Enable signals from data microprocessor(s) (1.d) controlling voltage regulator(s) that are themselves controllable (1.c).

105.—Power bus from controllable voltage regulators (1.c) supplying wireless communication module(s) (1.f), and the controllable voltage booster circuit(s) (1.g), the electronic display(s) (1.h) and amplifier circuits for actuator(s) (1.i).

106.—Clock signals supplying data processor(s) (1.d) coming from piezoelectric or ceramic oscillators (1.e).

107.—Serial data bus between data microprocessor(s) (1.d) and wireless communication module(s) (1.f).

108.—Enable signals from data microprocessor(s) (1.d) controlling voltage booster circuit(s) that are themselves controllable (1.g).

109.—Serial data bus between data microprocessor(s) (1.d) and electronic display(s) (1.h)

110.—Enabling signals from data microprocessor(s) (1.d) controlling amplifier circuit(s) for the actuator(s).

112.—Monitoring analogical signals of batteries from the battery charge sensors (1.n) which enter into the data microprocessor(s) (1.d)

113.—Power bus from the controllable voltage booster circuit(s) (1.g) that supplies the electronic display(s) (1.h).

114.—Power signals coming from the amplifier circuit(s) for the actuator(s) (1.i) which supplies the actuator(s) (1.j).

115.—Power bus that interconnects batteries (1.l) and battery charge management circuit(s) (1.m) to charge the batteries and supply the system.

116.—Bus for charge monitoring signals from battery charge management circuit(s) (1.m) that enter into the data microprocessor(s) (1.d)

117.—Power bus and/or interconnection data with an external system.

118.—Activation signal(s) produced by integrated or associated circuitry of general-purpose sensing components (1.a) that enter into the data microprocessor(s) to control the functional status of the system.

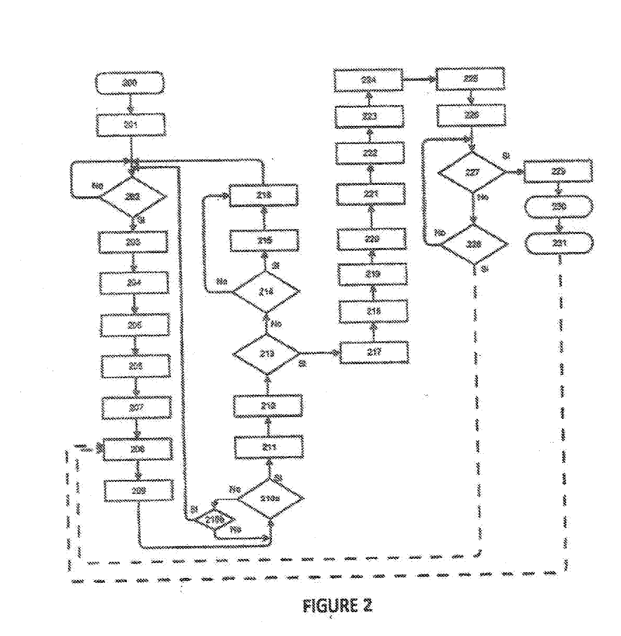

FIG. 2 illustrates the method to control operations of the portable electronic device in order to optimize battery power saving.

The method begins with one step (200), at a starting mode of the system, when all components are still unenergized. The charge management circuit(s) (1.m) are the first component(s) to be energized whenever voltage coming from one or more batteries is applied through the power bus (115) or an external power supply connected to the serial data bus (117). The charge management circuits (1.m) are capable of selecting actively (201) between the two power buses (117, 115) and redirect this voltage to the variable power bus (103) in order to avoid stress or overcharging in the batteries.

The system stars operating when there is a voltage higher than a predetermined level (202—yes) in the variable power bus (103). Then, the always-active regulator(s) (1.b) turn(s) on (203) providing power to the general-purpose sensing component(s) (1.a) and to data processing circuit(s) (1.d) (205) via the power bus (102).

At the moment when the power bus (102) is activated, the data processing circuit(s) (1.d) turn(s) on (205) to initialize internal records, select(s) the oscillator (1.e) clock signal (106) as a clock source and configure(s) the features of general-purpose sensing component(s), by using the serial data bus (101) to generate activation signals (118) when detecting certain motion patterns in the physical phenomenon to be sensed (207). Subsequently, the general-purpose sensing component(s) (1.a) is (are) set to a lower sampling frequency and operated in a low-power mode (208). The data processing circuit(s) (1.d) stop or turn off their features (209), except for the external interruptions, in order to reactivate as soon as the activation signal mode (118) changes (2010′—yes and 210b—no). Thus, the device stands by until a motion pattern is detected.

The system is in standby mode (210a and 210b) until a specific motion pattern is detected (210a—yes) or the voltage in the power bus (103) drops below certain specific level (210b—yes), which produces the total shutdown of data processing circuit(s) (1.d), general-purpose sensing components (1.a) and always-active regulator(s) (1.b). In this case, the system will reboot until it has reached a specific level in the power bus (103) (202—yes).

When the system is in standby mode and a motion pattern is detected (210a—yes) by the sensing components (1.a), the activation signal status (118) changes in order to reactivate data processing circuit(s) (1.d) and enter into operation mode (211).

Once the data processing circuits (1d) are reactivated (211), the bus of logical signals (116) and the analogue signal(s) (112) are monitored (212) to determine battery charge status, the charge level and, if applicable, the presence of an external voltage supply. Once this data is acquired, the processing circuits (1.d) calculate whether there is enough charge to execute one of the following options: 1) complete system operation (213—yes), 2) notify the user (215) that the device has low charge (214—yes) by a message displayed on the screen or through any of the actuators to then turn off the system (216) and return to standby mode (202), or 3) turn the system off directly (2014—no) and return to standby mode (202).

If there is enough charge level for system operation, the processing circuits (1.d) set its internal records and the clock source to operate as quickly as possible (217). Then, the processing circuit (1.d) internally executes the electronic screen controller(s) (218) (1.h), the wireless communication module(s) controller(s) (1.f) and the extended controller of sensing components (1.a). Once the controllers are charged, the voltage regulator(s) with controllable enabling (1.c) is activated by the signals (104) (219). This allows the supply of power to the wireless communication module(s) (1.f), the voltage booster circuit(s) (1.g) and the electronic display(s) (1.h) or to the amplifier circuits for actuator(s) (1.i) via the power bus (105).

Once the whole system has been initialized and energized (219), a test of peripherals may be conducted (220); this is a sequence in which processing circuit(s) (1.d) activate the motors (1.j) through the enabling signals (110) or any other actuator during a pre-defined time period. Likewise, the general-purpose sensing components (1.a) are configured to operate with a faster sampling frequency (221); the wireless communication module(s) (222) are set by means of the serial data bus (107) and the electronic displays (1.h) are initialized (223). Then, the data processing circuits (1.d) activate (224) the voltage booster circuits (1.g) through the enabling signals (108) in order to supply the required voltage to the electronic displays (1.h) by means of the power bus (113) and send the power-on commands (225) through the serial data bus (109). The initialization step ends (226) when a welcome message is shown on the electronic displays (1.h) and the electronic device of the invention is ready to execute an application.

Then, an application is selected to be executed (227), which may be stored in the internal memory of the electronic device of the invention and/or in an external host device. If a specific period passes (228—yes) without selecting an application (227—no), the device may re-enter the low-power standby mode and wait for an activation pattern (208, 209, 210a and 210b).

When selecting an application (227—yes), all subsystems are set (229) to operate in the lowest power consumption mode allowing the invention device to execute applications (230) stored in the host system memory until the end of its execution (231); then, the device may enters into low-power consumption standby mode and wait for an activation pattern (208, 209, 210a and 210b).

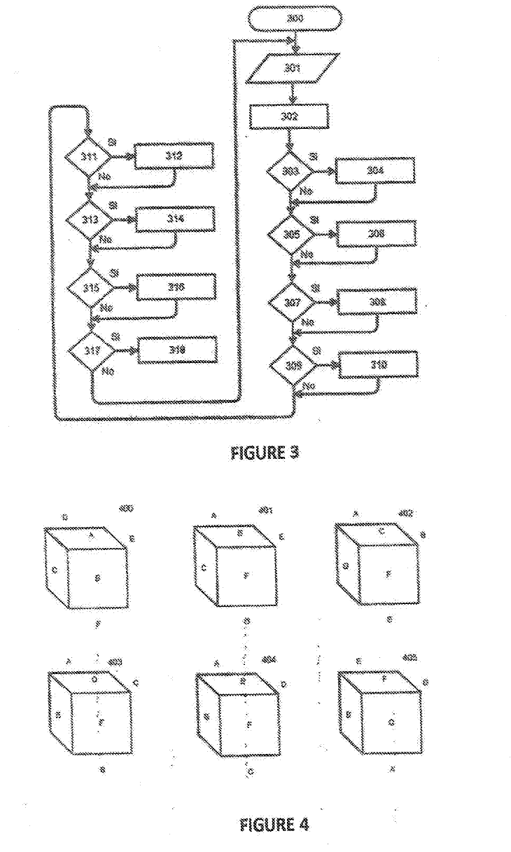

FIG. 3 shows the application execution and the battery usage management in the portable electronic device.

In addition, data processing circuits (1.d) always maintain a process (300) which calculates (302), based on user's movements (FIG. 4) obtained from general-purpose sensing components (301), whether to keep the electronic display(s) (1.h) turned on (303 and 304) and/or to change the brightness and/or contrast (305 and 306), to change the connection request frequency of wireless communication (307 and 308), to change acquisition frequency of general-purpose sensing components (309 and 310), to change the clock source (311 and 312), to notify the user about low-battery (313 and 314), data saving (315 and 316) or, as the case may be, turn off the system (317 and 318), among other possible actions to determine the optimal battery consumption in real time and distribute power as required.

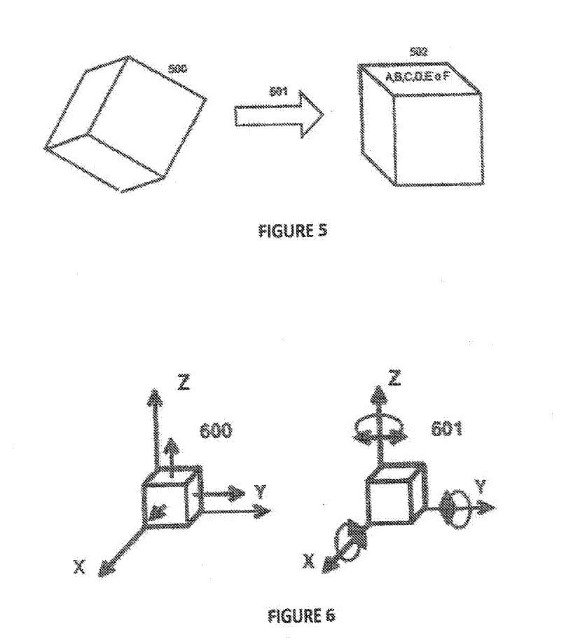

FIGS. 4, 5 and 6 show the user gestures that may determine, without limitation, from the possible positions of the invention device, when side A points upwards (400), when side B points upwards (401), when side C points upwards (402), when side D points upwards (403), when side E points upwards (404), when side F points upwards (405), the change (501) of a known or unknown position (500) to one of the 6 positions (502) and by analysis of translational movement (600) or rotational movement (601) in any of the three axes.

In order to execute applications stored in the memory of an external host, the data processing circuits (1.d) enable—within the wireless communication modules (1.f)—their visibility and the peering feature to allow incoming connections from an external host system, which may be a smartphone or any system with wireless communication support of the same kind.

Most of the time, data processing circuits (1.d) execute functions related to charge management, data reading of sensing components (1.a) and the updating of electronic displays (1.h); consequently, data reception is carried out through interruptions, i.e. when an incoming communication is detected by a serial port of processing circuits (1.d) originating from wireless communication module(s) (1.f) via serial data bus (107), the processing circuits (1.d) put the sequence being executed at that time on hold in order to manage the data arriving wirelessly. Once the communication is over, the processing circuits (1.d) determine, based on the information received, whether to take up the sequence where it was left before the interruption or to instead execute another sequence depending on the received data. Data transmission to the host is conducted by demand, i.e. a sequence is executed upon host request and/or by any user action, or by a change of program status in the main execution thread.

The application can control sensors, actuators and/or electronic display(s) of the invention electronic device as required by the objective of the application and may depend on, without limitation, transmitted and/or received data, movements and/or actions made by the user or the surroundings and events of external services, among others.

Communications are classified in: the transmission of configuration commands from the host to the invention device, the transmission of data (text, drawing instructions and encrypted images, among others) from the host to the invention device, the transmission of commands from the invention device to the host and the transmission of data (values measured by the sensing components) from the invention device to the host.

The transmission of commands from the host to the invention device is focused on the device configuration, as well as on certain parameters of the application that are related to the update time and shutoff of the electronic display(s) (1.h), the wireless connection request time from the device to the host, the sampling frequency of sensing element(s) (1.a), motor ignition time (1.j), the type of sound emitted by the speaker or the settings related to battery charge management in general.

The transmission of data (text, drawing instructions, notification instructions and encrypted images, among others) from the host to the device refers to the moment in which the host sends an operation code followed by the data involved in a given operation. Four types of data are recognized:

Plain text presented to the user, as determined by the application, on the electronic display(s) (1.h); drawing instructions representing drawing parameterized primitives such as isolated pixels, lines, squares, rectangles and triangles on the electronic display(s) (1.h). Notification instructions are commands that activate the motor(s) (1.j), as required by the application, and the sending of encrypted images drawn in the electronic display(s), pixel by pixel, as they arrive to the device or by some buffer system.

The transmission of commands from the device to the host is conducted when the device requires to send information about its status or the status of the application in progress to the host system for further processes. The information sent to the user includes, but is not limited to, battery charge status, charge level, connection requests of data and use of information, among other possibilities.

The transmission of data (values measured by the sensing components) from the device to the host is conducted on demand by the application or if requested by either the host or the devices processes.

The host is in charge of selecting, interconnecting, processing and/or managing on-line services that interact with the invention device.

Commands and data received and executed as a set of instructions in the device are stored in a readable medium such as RAM or the non-volatile memory of the device, which along with the processing circuit develop one or more methodologies of the actions mentioned above.

With regard to device structure, the case is a structure that may be made from one or more materials, with the necessary dimensions to support all invention device components allowing its effective and efficient operation. Furthermore, it may or may not contain a port, fixing mechanisms and/or electric terminals and/or connectors, among other additives as part of the coupling and de-coupling method.

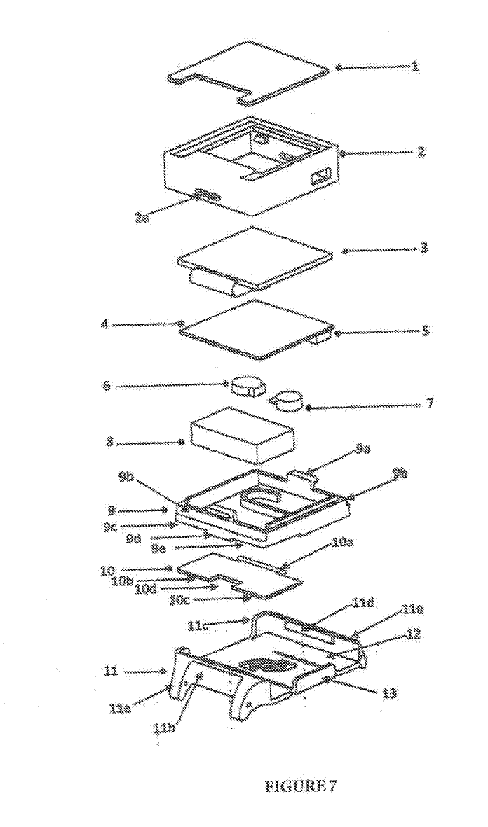

As shown in FIG. 7, a case or shell (2) coupling and de-coupling method is provided; this allows the assembly or disassembly of the invention electronic device in an autonomous system consisting of a base (11) through a mechanical connection system in which there may or may not be electrical terminals to interconnect power and/or data buses for the identification and exchange of information with the system on which the device is fixed. The autonomous system may or may not have different sensors, actuators, radio communications, microprocessors and additional batteries which may be enabled for information exchange with the invention device by means of a serial connection.

That is, an application modality of the present invention is a portable electronic device connected to a base (11) for use on a user's limb and controlled by gestures or movements, acting as an extension of the arm, forearm, wrist, foot; and it is further understood that it can be placed on a band over the user's head.

The device (which may be a watch, for example, as well as another device), comprises a main case (2) with a housing area with fixing mechanisms and electrical terminals to connect a portable electronic device.

The power-saving portable electronic device for the execution of applications by user movements or touch inputs consists of movement sensors configured to detect a movement around a virtual axis fixed at the user limb; a controller (4) to configure at least one function based on a movement signal so that it controls, manages and optimizes battery usage of the device through a microprocessor associated to a storage medium and a clock, allowing the device to enter standby mode through energized circuits of charge management; de-energize input and output components through an active voltage regulator and a controllable enabling regulator, except for the microprocessor and input components; as well as activating a low-power operation mode in the microprocessor and input components pending a signal acquired by a motion pattern to then enter into an activation mode.

In a preferred mode, the device consists of a lid (9) with a front surface forming an internal housing with perimeter edges and a rear surface; two fixing flaps (9a) are installed on the perimeter edges. At the same perimeter side on which the fixing flaps (9a) are located, there are some longitudinal slots (9b). The rear surface of the lid (9) has pivoting slots coupled to a rotatory support (10), whose function is to hold the device in an upright position when disconnected from the base (11) and is to be placed on a table or on the user's desk.

For the coupling between the lid (9) and the rotatory support (10), the rear surface of said lid (9) consists of a recess (9c, 9e) with a lug (9d) that matches the rotatory support shape (10) which consists of wings (10b, 10c) and a slot (10d) that, as mentioned before, matches in shape with the recess (9c, 9e) with a lug (9d) from the lid (9).

The internal housing of the lid (9) comprises a primary receptacle receiving a battery (8) and a second receptacle receiving a transducer (6) and a vibrator (7). Furthermore, the internal housing of the lid (9) comprises means to receive a board (4) and a display (3) that is mounted to internal elements.

Finally, a cover (2) comprising in its outer periphery at least one coupling slot (2a) is attached on the lid (9). In this coupling slot (2a) the fixing flaps (9a) for the cover (9) are received to maintain a fixed connection between parts. The cover (2) consists of coupling means receiving a screensaver (1) that protects the internal display (3).

Once the cover is fully assembled, it would be the power-saving portable electronic device of this invention and it would be connected to and disconnected from the base (11); for this purpose, the base consists of three limiting walls that create a coupling space and a lower surface (12). Two of the walls (11a, 11b) are facing each other and the third wall (11c) is between them (11a, 11b). The internal surface of the walls (11a, 11b) has longitudinal guides (11d) which lead and receive the cover (2) sliding through the slot inside the space of the base (11). The aforementioned sliding takes place through the interaction between longitudinal slots (9b) and longitudinal guides (11d). In order to keep such coupling fixed, the lower surface of the base (11) has in the middle part a flexible holder (13) which maintains the cover (2) fixed on its position over the base (11), pushing said case against the limiting walls (11a, 11b, 11c).

A notable structural characteristic of the base (11) are its coupling means (11e) that can hold a band or strip, which would serve to maintain the entire device at a certain position, such as at a user's limb (the hand, head, forearm, etc.).

1. A portable electronic device that manages its own power from touch or motion inputs for the execution of applications, comprising:
A main cover (2) with one or more coupling mechanisms, either mechanical or electrical, for the input of an external supply;
A housing area (9) comprising:
One or more processing circuit(s) (1.d), supplied by an internal battery (1.l) or an external supply and a charge management circuit (1.m) connected to input-output elements, always-active voltage regulation circuit(s) (1.b) and controllable enabling circuits (1.c), voltage booster circuits (1.g) and one or more amplifier(s) for the actuator(s) (1.i);
The processing circuit(s) (1.d) is (are) configured to control, manage and optimize battery usage of the device through a microprocessor associated with a storage medium and a dock (1.e), which enables the device to enter standby mode through charge management circuit(s) (1.m); and activating a low-power operation mode in the microprocessor circuits and input components pending a signal acquired by a motion pattern detected by a sensor to then enter into an activation mode.

2. Portable electronic device according to claim 1, further characterized in that input components may be a wireless communication module (1.f) or sensors (1.a) that measure physical variables.

3. Portable electronic device according to claim 2, further characterized in that sensors (1.a) measuring physical variables may be motion, temperature, rotational acceleration, luminous intensity, pressure or humidity sensors.

4. Portable electronic device according to claim 1, further characterized in that output components may be a display (1.n) and other actuators (1.j).

5. A method to control operations of a portable electronic device to manage its own power supply from touch or motion inputs for the execution of applications, which comprises the following steps:
A step (200) to supply power to charge managements circuits (1.m) in order to put the device in start-up mode when voltage from a device battery (1.l) is applied;
A step (202) to begin device operations when there is a voltage value in the charge management circuit input higher than a certain predetermined level, by turning on an active voltage regulator (1.b) to supply input components and processing circuits (1.d);
A step (206) to start various internal records through processing circuits (1.d) to configure functions of input components to product activation signals when detecting a motion pattern;
A step (211) to enter activation mode when an input motion pattern is detected by the input components and fully activates the processing circuits (1.d);
A step (213) to put the device system in full operation;
A step (220) to execute a peripheral test and activate input and output components through processing circuits (1.d) for the execution of a specific application and the management of battery use (1.l) during the execution of such application.

6. The method of claim 5, further characterized in that in the step (200) where the device begins operations, the charge management circuits are capable of actively selecting voltage from the device battery (1.l) or from the external supply if it is connected.

7. The method from claim 5, is further characterized in that in step (212) of battery voltage determination, if the voltage drops below a specific level, a step (214) to fully turn-off the device is performed; then, it will be necessary to return to a start-up mode step (202) when reaching a specific charge level and begin from the start-up step (206).

8. The method from claim 5, further characterized in that in the motion pattern determination step (210a), if a motion pattern has not been detected, return to the motion pattern determination step (210a).

9. The method from claim 5, further characterized in that in the step (212) for determining whether the battery has enough charge for the full system activation, a step (215) is executed to notify the user that there is not enough charge by a message box on the display (1.h) or by any actuator to then begin another step (216) and turn off the device.

10. A medium that can be read on a portable device containing the steps of a method that, when executed, results in steps to control portable device operations for power saving through user motions or touch inputs, wherein the method comprises:
A step (200) to supply some charge management circuits (1.m) in order to put the device in a start-up mode when voltage from a device battery (1.l) is applied;
A step (202) to initiate device operation when reaching a voltage value higher than a certain preestablished level in the charge management circuit input, which will turn on an active voltage regulator (1.b) to supply input components and processing circuit(s) (1.d);
A step (206) for initiating several internal registers by the processing circuit(s) (1.d) to configure the functions of input components to generate the activation signals upon detecting a motion pattern;
A step (211) for entering an activation mode when a motion pattern is sensed by the input components and fully activates the processing circuit(s) (1.d);
A step (213) for bringing the device system into full operation;
A step (220) for performing a peripheral test and activating the input and output components via the processing circuit(s) (1.d) to execute a specific application and manage battery usage (1.l) during the execution of said application.

11. The readable medium of claim 10, further characterized in that the step (200) where the device is started, the charge management circuit(s) is (are) able to actively select the voltage from the battery (1.l) of the device or external supply if it is connected.

12. The readable medium of claim 10, further characterized in that in the step (212) for determining battery voltage, if the voltage drops below a specific level, a step (214) is performed to shut down the device and return to a start-up mode step (202) when a specific charge level is reached and return to the starting step (206).

13. The readable medium of claim 10, further characterized in that in the step (210a) for determining a motion pattern, if no motion pattern has been detected, it returns to the step (210a) for determining a motion pattern.

14. The readable medium of claim 10, further characterized in that in the step (212) of determining whether the battery charge does not have enough charge for full system activation, execute a step (215) to warn the user that there is low charge by a message on the screen (1.h) or by means of some actuator, to then continue to another step (216) and shut down the device.

15. Portable electronic device that manages its own power supply, connected to a base to be used on a user's limb and controlled by gestures or movements, comprising:
A main cover consisting of a housing area with holding mechanisms and electrical terminals to connect a portable electronic device;
A portable electronic power-saving device for executing applications by means of user's motions or touch inputs comprising:
Motion sensors (1a) configured to detect a movement around a virtual axis at the user's limb;
One or more processing circuit(s) for setting at least one function based on a motion signal to control, manage and optimize battery usage of the device through a microprocessor associated with a storage medium and a clock.
This enables the device to enter the initial standby mode through powered circuits of charge management, de-energize input and output components through an active voltage regulator and one controllable enabling regulator, except for the processing circuits (1.d) and input components, as well as activating a low-power operation mode in the processing circuits (1.d) and input components pending a signal acquired by a motion pattern to then enter activation mode.

16. A portable electronic device connected to a base for use on a user's limb and controlled by gestures or movements, according to claim 15, characterized in that the cover (9) comprises a front surface forming an inner housing with perimeter edges and a rear surface, two securing flaps (9a) are installed on the perimeter edges. On the same perimeter side where the securing flaps (9a) are found, there are longitudinal slots (9b), and where the rear surface of the lid (9) has pivoting slots to which a rotatable holder (10) is connected to maintain the device in an erected position when disconnected from the base (11) and is to be placed on a table or on the user's desk.

17. A portable electronic device connected to a base for use on a user's limb and controlled by gestures or movements, as mentioned in the preceding claim, characterized as the coupling between the lid (9) and the rotating support (10), is conducted since the rear surface of said cover (9) comprises a recess (9c, 9e) with a lug (9d) that matches with the shape of the rotating support (10) formed by wings (10b, 10c) and a slot (10d).

18. A portable electronic device connected to a base for use on a user's limb and controlled by gestures or movements, as mentioned in claim 15, characterized in that the cover (9) has an inner housing comprising a primary receptacle receiving a battery (8) and a second receptacle receiving a transducer (6) and a vibrator (7), and wherein said inner housing of the lid (9) further comprises means for receiving a card (4) and a display (3) that is mounted to the internal components.

19. A portable electronic device connected to a base for use on a user's limb and controlled by gestures or movements, as mentioned in claim 15, characterized in that the base (11) comprises three limiting walls that generate a coupling space and a lower surface (12) wherein two of the walls (11a, 11b) are facing each other and the other wall (11c) lies between said walls (11a, 11b); and the inner surface of the walls (11a, 11b) has longitudinal guides (11d) which lead and receive the cover (2) Into the space of the base (11), wherein the aforesaid sliding is carried out by means of the interaction between the longitudinal slots (9b) and the longitudinal guides (11d).

20. A portable electronic device connected to a base for use on a user's limb and controlled by gestures or movements, as mentioned in the preceding claim, characterized in that the lower surface (12) of the base (11) has in its middle part a flexible holder (13) which holds the cover (2) on the base (11) in its fixed position by pushing said case against the limiting walls (11a, 11b, 11c).

21. A portable electronic device connected to a base for use on a user's limb and controlled by gestures or movements, as mentioned in claim 15, characterized in that the base (11) comprises coupling means (11e) to hold a band or strip, which would have the function of holding the whole device in any position.
